(19) United States
(12) Patent Application Publication
(10) Pub. No.: US 2018/0225419 A9
(43) Pub. Date: Aug. 9, 2018

(54) Remote Patient Monitoring System

(71) Applicant: Medtronic, Inc., Minneapolis, MN (US)

(72) Inventors: Emily ANTHONY, Minneapolis, MN (US); Brian L. Bechard, Oakdale, MN (US); Jennifer A. Alwine, Maple Grove, MN (US); Keith K. Holloman, Brooklyn Park, MN (US); Nirav V. Sheth, Maple Grove, MN (US); Teresa A. Whitman, Dayton, MN (US); Jennifer M. Ramseth, St. Paul, MN (US); Chemuttaai K. Lang'at, Lantana, TX (US); Christina Chow, Portsmouth, NH (US); Daniel M. Gelfman, Golden Valley, MN (US); Molly Guy, Blaine, MN (US); Daniel Grossman, Minneapolis, MN (US); Jote Taddese, Plymouth, MN (US)

(73) Assignee: Medtronic, Minneapolis, MN (US)

(21) Appl. No.: 15/290,541

(22) Filed: Oct. 11, 2016

Related U.S. Application Data
(60) Provisional application No. 62/240,963, filed on Oct. 13, 2015.

(51) Int. Cl. G06F 19/00; G08B 21/02

(52) U.S. Cl. CPC G06F 19/3418; G08B 21/02; G06F 19/322

(57) ABSTRACT

Techniques for systems and methods for remotely monitoring a patient are provided. The system comprises a plurality of input sources operable to acquire patient-specific information corresponding to a condition of a patient. A patient-centric threshold is computed based on relevant environmental, cultural, societal, religion, and economic data for evaluation of the acquired physiological parameters. Risk stratification is performed to determine the risk level of the patient based on the patient-centric threshold, and a recommendation is generated. The recommendation includes a treatment/care plan that can consist of prescriptions and patient education tailored to the risk stratification and patient-specific information.

### FIELD

The present disclosure relates to patient monitoring of chronic medical conditions.

### BACKGROUND

In developing countries, non-communicable and chronic diseases are a prevailing health concern. In this environment, personal, cultural, and economic conditions, as well as lack of adequate healthcare infrastructure play a major role in the delivery and efficiency of patient care. In developed countries, efforts to reduce healthcare costs, alleviate staffing constraints within healthcare facilities, and provide better care for patients have led to an increase in the use of remote patient monitoring devices. Remote patient monitoring devices allow patients to independently monitor a variety of health metrics, such as weight, blood glucose or blood pressure. Accordingly, remote patient monitoring can drastically improve healthcare outcomes for patients by informing their health care providers of the patient's health metric and physiological information on a more frequent and convenient basis.

Despite the many benefits of remote patient monitoring devices, healthcare providers are currently unable to customize the type and frequency of health metric information they receive from such devices. Most data received from monitoring devices is condition-specific (i.e., it relates to a condition, such as diabetes). However, the experience in developing countries has shown that health conditions are typically impacted by factors such as culture, environment, and lack of access to healthcare. Poor infrastructure, in addition to a variety of other patient-specific variables such as, age, gender, type and severity of disease, genetic history, religious and tribal practices, specifically contribute to lack of timely care.

Conventional condition-specific monitoring does not take into account such cultural and environmental factors in connection with patient-specific variables. As a result, healthcare providers may underestimate or overestimate the significance of remotely-monitored health metric information for different patients. Therefore, while physiological parameters will play a significant role in the diagnosis and treatment of patients, tailoring patient care to both the personal and cultural conditions/environment of the patient in developing countries will result in effective and efficient delivery of health care.

Accordingly, there is a need to provide improvements in remote patient monitoring.

### BRIEF SUMMARY

The disclosure describes systems, methods and techniques that combine aspects of advanced existing monitoring technology, with a novel data management and processing system to effectively personalize the therapy being delivered to each of the patients being monitored. In accordance with embodiments of the disclosure, patient information is acquired by patient monitoring portals that monitor, collect, evaluate and store the patient information associated with a health condition of the patient. The patient information is processed to generate recommended therapy or care plans for the patient. The system facilitates a provider to access the patient's information in real time.

A remote monitoring computing system is in effect the engine that drives a monitoring and communication operations of all standalone components, devices, and programs of the system. The system possesses two-way communication capability both managing all peripherals used to remotely monitor, collect, analyze and store valuable patient health information on a 24/7 basis and forward crucial monitored information to a provider. The provider reviews the information and makes, confirms or modifies a treatment/care plan, to promote the continued health and welfare of their patients. The system facilitates efficient close monitoring, and avoidance of common patient complications that often result in costly frequent patient visits to the emergency room, admissions and/or re-admission. The system is fully automated, functioning independent of human intervention, to remotely monitor, collect, receive, store and relay crucial data as desired to the patient's physician. It supports all patient monitoring devices and communications and, when determined appropriate, sends on the patient data results to their respective providers for review.

In accordance with an embodiment, a computing system for remotely monitoring a patient is provided that includes a patient-portal having a plurality of input sources operable to acquire patient information corresponding to a condition of the monitored patient. The computing system includes a patient database that stores baseline characteristics of a population including the patient, the baseline characteristics including, for example, information regarding the culture, environment, societal norms, religion, and economic conditions of the monitored patient, as well as information regarding the condition of the patient. In accordance with some embodiments, an integrator is communicatively coupled to the patient-portal and the patient database and the integrator is configured to select a sub-set of the baseline characteristics as a function of the patient condition and aggregate the selected sub-set of the baseline characteristics to generate a patient-centric threshold associated with the condition of the monitored patient. A processing device is provided for performing a risk stratification of the acquired patient information based on the patient-centric threshold to determine a patient status of the patient and generate a recommendation based on the determined patient status.

In accordance with another embodiment, a non-transitory computer readable medium includes instructions that are executable by a remote monitoring computing system to cause the system to acquire patient information corresponding to a condition of the patient, generate a patient-centric threshold corresponding to the condition of the monitored patient, compute a risk stratification of the patient condition and generate a recommendation based on the result of the risk stratification.

Another embodiment is a method for remotely monitoring a patient by a remote monitoring computing system that includes the tasks of acquiring patient information corresponding to a condition of the monitored patient, generating a patient-centric threshold corresponding to the condition, performing a risk stratification of the acquired patient information and generating a recommendation based on a determined patient status of the patient.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWINGS

The following drawings are illustrative of particular embodiments of the present disclosure and therefore do not limit the scope of the disclosure. The drawings are not to scale (unless so stated) and are intended for use in conjunction with the explanations in the following detailed description.

Embodiments will hereinafter be described in conjunction with the appended drawings wherein like numerals/letters denote like elements, and:

FIG. 1 is a schematic plan view of a remote monitoring computing system for remotely monitoring a patient, in accordance with embodiments of the present disclosure;

FIG. 2 is a block diagram depicting an exemplary set of content comprising a data store, in accordance with embodiments of the present disclosure;

FIG. 3 is a block diagram illustrating an exemplary patient portal in accordance with embodiments of the present disclosure;

FIG. 4 is a flowchart illustrating a method or process for remote patient monitoring, in accordance with embodiments of the present disclosure;

FIG. 5 is a flowchart illustrating a method or process performed by a patient portal during remote patient monitoring, in accordance with embodiments of the present disclosure;

FIG. 6 is a flowchart presenting an overview of a method or process of remote patient monitoring, in accordance with embodiments of the present disclosure;

FIG. 7 is a flowchart presenting an overview of a method or process of remote patient monitoring, in accordance with embodiments of the present disclosure;

FIG. 8 is a flowchart presenting an overview of a method or process of remote patient monitoring, in accordance with embodiments of the present disclosure; and

FIG. 9 is a flowchart presenting an overview of a method or process of remote patient monitoring in accordance with embodiments of the present disclosure.

### DETAILED DESCRIPTION

This disclosure describes techniques, methods, computer systems, and computing storage media for remotely monitoring a patient to monitor, assess or treat a condition of the patient.

Initially, a healthcare provider creates or logs in to a patient profile that stores and presents information about remotely-monitored medical information for a patient. Within the patient profile, the healthcare provider can customize monitoring parameters for the patient's information by inputting monitoring metrics into the patient profile. Exemplary monitoring metrics includes a frequency of monitoring, a type of physiological parameter to be monitored, a number of parameters to monitor, patient-specific threshold values used to determine a criticality of a parameter, and conditions under which alerts should be communicated to one or more healthcare providers, the patient, or other third parties consented to by the patient.

A criticality of the patient condition being monitored is determined based on a risk stratification analysis yielding a conclusion that the patient status associated with the acquired patient information falls into one of the patient-centric threshold values already associated with a defined criticality. The criticality determination is used to assign a health alert status to each patient status and/or to communicate an alert to a healthcare provider. If a patient's status reaches a predefined criticality level, an alert may be communicated to at least one of the patient's healthcare providers. In this way, customized alerts may carry special significance to healthcare providers, leading to potentially quicker response times and more effective care.

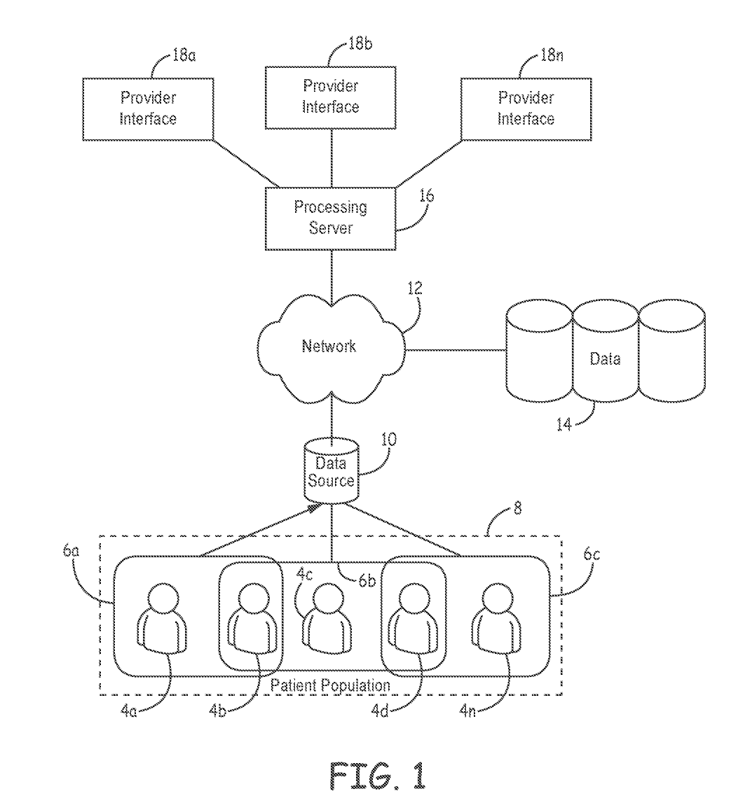

An exemplary remote monitoring environment suitable for use in implementing embodiments of the present invention is described below. FIG. 1 is an exemplary remote monitoring computing system 2 (e.g., medical-information computing-system environment) with which embodiments of the present invention may be implemented.

The remote monitoring computing system 2 is merely an example of one suitable computing environment and is not intended to suggest any limitation as to the scope of use or functionality of the invention. Neither should the remote monitoring computing system 2 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include cell phones, tablets, wearable devices, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the remote monitoring computing system 2 includes a computing device in the form of a processing server 16. Exemplary components of the processing server 16 comprise a processing device and internal system memory. The processing device can include any one or more of a microprocessor, a controller, a digital signal processor (DSP), an application specific integrated circuit (ASIC), a field-programmable gate array (FPGA), or equivalent discrete or integrated logic circuitry. In some examples, the processing device can include multiple components, such as any combination of one or more microprocessors, one or more controllers, one or more DSPs, one or more ASICs, or one or more FPGAs, as well as other discrete or integrated logic circuitry. The functions attributed to the processing device in this disclosure can be embodied as software, firmware, hardware or any combination thereof. The processing device also need not be a digital signal processor-based architecture, but other architectures, such as the logic or state machine architectures or other components or circuitry for performing a processing function, are contemplated in the present disclosure. Such architectures are not discussed in detail herein merely for the sake of brevity.

A suitable network 12 is provided for coupling various system components, including provider interface 18a-18n (collectively “provider interface 18”), data store 14, patient data source 10 and patient-portal network 6 to the processing server 16. The network 12 can include any suitable wired and/or wireless connectivity system such as local area networks (LANs) mobile telecommunications network, and/or wide area networks (WANs). Such networking environments are commonplace in offices, enterprise-wide computer networks, intranets, and the Internet.

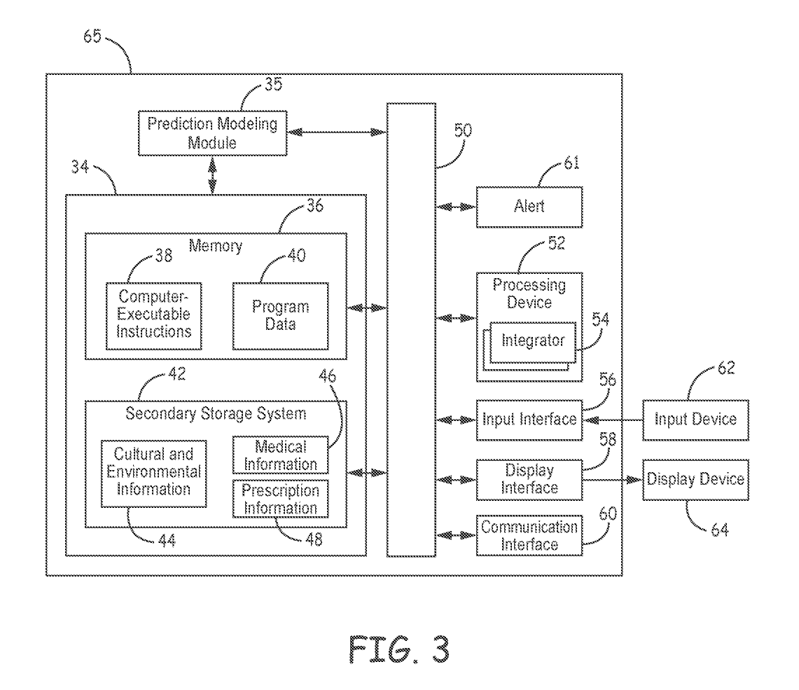

The patient-portal network 6 includes a plurality of patient-portals 4a-4n (collectively “patient-portal 4”). Each of the patient-portals 4a-4n can be used to acquire patient information from a single patient or from multiple patients. The patient-portal 4 will be described in more detail with reference to FIG. 3. Briefly, the patient-portal 4 can include patient-specific input devices (FIG. 3) that acquire patient information and transmit that information into the patient-portal network 6 for transmission to the data source 10.

The patient-portal network 6 resides within a patient population 8. The patient population 8 includes a plurality of patients who reside in the community and/or vicinity of a given patient who is being remotely monitored. The community can include the patient's immediate family, extended family, neighborhood, city, or any other demarcation of the individuals surrounding the patient. The population can include other patients who have similar conditions as the monitored patient, or individuals who have other conditions that are unrelated to the patient's condition, or otherwise healthy individuals.

In exemplary embodiments, the data source 10 is a database that stores information such as the acquired patient information, the results of the analysis by the processing server 16, information provided through the provider interface 18, selected data from the data store 14, and/or the electronic medical records of the patients in the patient population 8. Examples of the database of data source 10 can include a server or a mobile telecommunications network server.

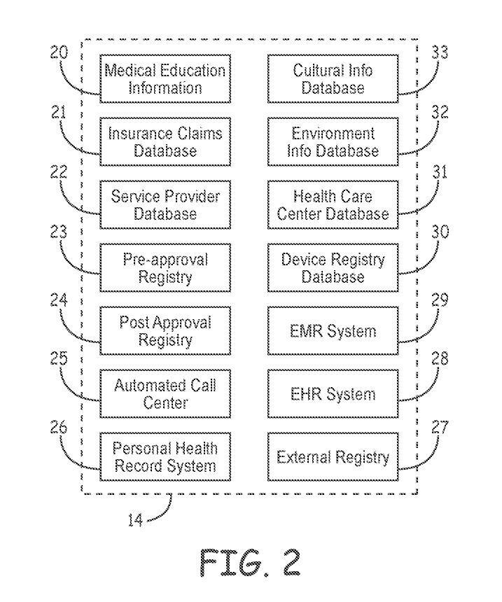

Data store 14 comprises one or more databases that contain information about the patients being monitored by the remote monitoring computing system 2 as well as general information about the population in which those patients reside. For example, the information in the data store 14 may include health-related information, cultural information, medical educational information, financial information, population literacy information, environmental information and any other information that is relevant to the health and well-being of a population. Examples of sources that can comprise the data store 14 will be described with reference to FIG. 2. The information stored in the data store 14 comprises the baseline characteristics of the population or sub-population of patients being monitored.

The processing server 16 typically includes therein, or has access to, a variety of computer-readable media. Computer-readable media can be any available media that might be accessed by control server 16, and includes volatile and nonvolatile media, as well as, removable and non-removable media.

By way of example, and not limitation, computer-readable media may comprise non-transitory computer storage media. Non-transitory computer storage media includes volatile and nonvolatile, removable and non-removable media implemented in any method or technology for storage of information such as computer-readable instructions, data structures, program modules or other data. Non-transitory computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by processing server 16.

The provider interface 18 can be personal computers, servers, routers, network PCs, peer devices, other common network nodes, or the like and might comprise some or all of the elements described above in relation to the processing server 16. The devices can be personal digital assistants or other like devices. The provider interfaces 18a-18n might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Providers can comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like.

The provider interface 18 is used by the provider to review information such as the acquired patient information or the results of the analysis performed by the processing server 16. The provider interface 18 can also be used to input information from the provider, such as diagnosis and treatment/care plans, that is to be stored in the patient's medical record and/or transmitted to the patient-portal 4 for the patient. Accordingly, the provider interface 18 will include one or more data entry features for entry of input from the provider. Example data entry features include textboxes, text areas, radio buttons, checkboxes, drop-down boxes, and other on-screen features that receive input from the provider or other users.

The components of the remote monitoring computing system 2 such as the provider interface 18, data store 14, patient data source 10 and patient-portal network 8 might also be physically located in non-traditional medical care environments so that the entire healthcare community might be capable of integration on the network.

It will be appreciated by those of ordinary skill in the art that the network connections shown are exemplary and other means of establishing a communications link between the various components of the remote monitoring computing system 2 can be utilized. Although many other internal components of the remote monitoring computing system 2 are not shown, such components and their interconnection are well known. Accordingly, additional details concerning the internal construction of the remote monitoring computing system 2 are not further disclosed herein.

FIG. 2 is a block diagram depicting an exemplary set of content comprising data store 14. The exemplary data store 14 includes medical education information 20, an insurance claims database 21, a service provider database 22, a pre-approval study registry 23, a post-approval study registry 24, an automated call center 25, a personal health record system 26, an external registry 27, an electronic health record (EHR) system 28, an Electronic Medical Records (EMR) system 29, a device registry database 30, a healthcare center database 31, an environment information database 32 and a cultural information database 33.

In each case, one or more computing devices are configured to collect and/or deliver data to the data source 14. Readers will understand that the various items within data sources 14 are merely examples and that other examples can include more, fewer, or different data sources. It should also be noted that the data in each of the various items may be organized in varying formats or structures and data fields may not necessarily coincide for any given two data sources 104. To that end, the data source 14 facilitates generation of the baseline characteristics for the population or sub-population of patients being monitored.

The medical education information 20, cultural information database, environment information databases comprise information about the various medical conditions being monitored, the cultural background, norms and practices of the patients being monitored, and information about the environment of the patients being monitored, respectively.

The Insurance claims database 21 stores data regarding insurance claims filed by patients in population 8 (FIG. 1). The service provider database 22 will store information about the service providers available in the population. The pre-approval study registry 23 and post-approval study registry 24 can provide some or all of the data related to the pre-approval studies and post-approval studies in which one or more patients in the population are enrolled. The automated call center 25 comprises computing devices that make telephone calls to patients and collect information from these patients without the involvement of a human call center technician.

The personal health record system 26, electronic health record (EHR) system 28, and Electronic Medical Records (EMR) system 29 store electronic health records for some or all patients in population that are created and curated by the patients, providers and/or other users. The external registry 27 and healthcare center database 31 store data generated by one or more parties and organizations other than the patients and providers in the population, such as the Social Security death index, marketing companies, and others. Finally, the device registry database 30 includes information regarding various medical devices implanted in patients within the population, such as a model and serial number of the medical devices.

FIG. 3 is a block diagram illustrating an exemplary patient portal 4 in accordance with an embodiment. Patient portal 4 includes an input device 62, a display device 64 and a user interaction unit 65. Generally, the patient portal 4 acquires information pertaining to a condition of the monitored patient. The information can include responses to patient self-assessment questions, manual entries of the patient's physiological parameters, and/or automatically sensed physiological parameters of the patient. As illustrative examples, some of the patient conditions that can be monitored in accordance with embodiments of this disclosure include hypertension, diabetes, heart failure and other cardiac conditions, and various other maladies that can impact the normal health and well-being of the patient.

The input device 62 acquires patient information through any appropriate input technique such as manual entry or automatic data acquisition. For example, the input device 62 can be embodied as a keyboard to enable a user to input information such as responses to self-assessment questions or measurements of physiological parameters such as blood oxygen, blood pressure, weight, blood glucose and any other parameters associated with a condition of the patient. In other embodiments, the input device 62 is a sensor that is activated by the patient or automatically activated to measure the physiological parameters of the patient such as blood oxygen, blood pressure, weight, blood glucose and any other parameters associated with a condition of the patient. In other embodiments, the input device 62 includes a receiver that connects to a peripheral measurement device (not shown) that measures and transmits the physiological parameters of the patient such as blood oxygen, blood pressure, weight, blood glucose and any other parameters associated with a condition of the patient. In such embodiments, the receiver of the input device 62 will communicate with the peripheral measurement device to acquire the physiological parameters measured by the peripheral measurement device.

In other words, the input devices 62 fall into three categories. Some of the devices are self-sufficient stand-alone devices, such as input devices 62 that are integrated, or capable of communicating, with the patient portal 4 directly, for example, by using their own SLM/SIM card that provides them access to a cellular wireless data line.

The second category of input devices 62 are devices that communicate with intermediate devices via a wired or wireless connection. Examples of such devices are shown in Tables 1 and 2 below. The third category of input devices 62 are not really discrete devices but are described as such for the sake of clarity. These devices are implemented as applications on computing devices such as a laptop, tablet, wearable device, or smartphone. All the devices can communicate with the patient portal 4 in real time with little or no patient interaction.

The following tables show some sources for input devices 62 used for patient monitoring by the present invention:

TABLE 1
Bluetooth Devices

| | | |
|---|---|---|
| Glucometer | Manufacturer: | New Taipei City, Taiwan |
| Model: TD-4279 | Taidoc | |
| Blood Pressure | Manufacturer: | New Taipei City, Taiwan |
| Model: TD-3128 | Taidoc | |
| Pulse Oximeter | Manufacturer: | New Taipei City, Taiwan |
| Model: TD-8201 | Taidoc | |
| Pulse Oximeter | Manufacturer: | Qinhuangao, Hebei |
| Model: CMS50EW | Contec | Province, China |
| Weight Scale | Manufacturer: | New Taipei City, Taiwan |
| Model: TD-2551 | Taidoc | |
| Ear Thermometer | Manufacturer: | New Taipei City, Taiwan |
| Model: TD-1261 | Taidoc | |

TABLE 2
Wired Devices

| | | |
|---|---|---|
| Glucometer | Manufacturer: | Fort Lauderdale, Florida |
| Model: TRUEresult | Nipro | |
| Blood Pressure | Manufacturer: | Qinhuangao, Hebei |
| Model: contec08c | Contec | Province, China |
| Pulse Oximeter | Manufacturer: | Qinhuangao, Hebei |
| Model: CMS50D+ | Contec | Province, China |

Additional examples of patient information that can be acquired include health metric values that describe other physical or mental qualities about a patient, such as, for example, the number of steps a patient takes in a day. The patient information may pertain to multiple conditions of the patient. For instance, the number of steps a patient takes in a day can provide insight into not only the patient's recovery from a knee surgery, but also the extent to which the patient may be depressed.

In accordance with an embodiment, the input device 62 can be patient specific and will therefore include attributes to confirm an identity of the patient. For example, the input device 62 includes user authentication techniques such as secure sign-on procedures that include a password, fingerprint verification, voice recognition, facial recognition, iris recognition, hand geometry, signature recognition, or other form of biometric verification. Of course the input device 62 could also be a discrete sensor that is implanted into the body of the patient and in that case, no authentication procedure would be required and the sensor would be identifiable by the user interaction unit 65 as being associated with the patient. In other embodiments, the input device 62 may be integrated into the user interaction unit 65, in which case, the authentication procedures performed by the user interaction unit 65 will govern the patient identification. In other embodiments, the input device 62 is shared by a population or sub-population of patients.

Display device 64 is a display or monitor that provides a visual representation of information to a user. For example, the display device 64 displays self-assessment questions and responses provided by the patient, entries of information pertaining to physiological parameters of the patient, alerts, medication reminders, prescription information, medical education content provided to the patient or any other information that the patient or a user may desire to input pertaining to the condition of the patient and information that a user such as a provider may desire to provide to the patient.

User interaction unit 65 includes a storage unit 34, a processing device 52, an input interface 56, a display interface 58, a communication interface 60, and one or more communication media 50. Readers will understand that user interaction unit 65 can include components in addition to those shown in the example of FIG. 3. Furthermore, readers will understand that some computing devices do not include all of the components shown in the example of FIG. 3.

The processing device 52 can include any one or more of a microprocessor, a controller, a digital signal processor (DSP), an application specific integrated circuit (ASIC), a field-programmable gate array (FPGA), or equivalent discrete or integrated logic circuitry. In some examples, the processing device 52 can include multiple components, such as any combination of one or more microprocessors, one or more controllers, one or more DSPs, one or more ASICs, or one or more FPGAs, as well as other discrete or integrated logic circuitry. The functions attributed to processing device 52 in this disclosure can be embodied as software, firmware, hardware or any combination thereof. While the embodiment of FIG. 3 refers to a digital signal processor-based architecture, it should be noted that other architectures, such as the logic or state machine architectures or other components or circuitry for performing a processing function, are contemplated in the present disclosure. Such architectures are not discussed in detail herein merely for the sake of brevity.

The communication media 50 enable data communication between the various components of the user interaction unit 65. Communication media 50 include media over which one device can communicate data to another device. Example types of communication media include communication networks, communications cables, wireless communication links, communication buses, and other media over which one device is able to communicate data to another device.

Storage unit 34 is a system that stores data for subsequent retrieval. In the example of FIG. 3, storage unit 34 comprises a memory 36, a secondary storage system 42 both of which store data for later retrieval. In the example of FIG. 3, a memory 36 stores computer-executable instructions 38 and program data 40. Secondary storage system 42 stores a subset of the baseline characteristics data that is relevant to the patient such as cultural and environmental information 44, medical education 46 and prescription information 48. The storage unit 34 can be implemented as any of the aforementioned non-transitory computer storage media.

Processing device 52 reads computer-executable instructions from the memory 36 and executes the computer-executable instructions. Execution of the computer-executable instructions by processing device 52 causes patient portal 4 to perform the actions indicated by the computer-executable instructions. For example, execution of the computer-executable instructions by processing device 52 can cause patient portal 4 to provide patient information acquisition capability, information display capability, alert generating capability, or can cause patient-portal 4 to provide other functionality.

The user interaction unit 65 can be implemented as a custom device embodying the functionality described herein. Such a custom device could include a mobile telephone, tablet or wearable device operating a customized application, a computing device, a web interface, or any other suitable device.

The frequency of acquisition of the physiological parameters, whether through manual entry or automatic acquisition, is pre-determined and stored in the memory 36. An alert can be generated by the alert module 61 to remind a user such as the patient or a clinician about the scheduled information acquisition or if a scheduled information acquisition is missed.

The secondary storage system 42 includes among other things cultural and environmental information 44, medical information 46, and prescription information 48.

The cultural and environmental information 44 will include baseline characteristics of a population of individuals. In some embodiments, the individuals in the population will include the patient, or the patient's family. The baseline characteristics include information pertaining to the cultural and environmental parameters of the patient and various types of information that are relevant to the condition and/or treatment of a particular patient. The cultural and environmental parameters can include relevant traditional norms about treatment of the patient's condition, occupational conditions, sleep quality, resource availability, dietary conditions, environmental factors and any other parameters that impact the health and well-being of the patient and/or compliance with the prescribed treatment regimen or interact with the prescribed treatment regimen.

The medical information 46 can additionally constitute the baseline characteristics of the population of individuals. The medical information 46 will include information relating to, for example, patient identification information, images, condition history, physical examinations, vital signs, patient's family medical histories, surgical histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

In some embodiments, the parameters of each of the baseline characteristics can be expressed as numeric values graded on a predetermined scale, such as integer numbers 1 to 10, with 1 indicating the worst or high-risk score and 10 indicating the best or low-risk score. In other words, the risk scores classify the range of patient statuses that are associated with each condition.

Integrator 54 is configured to select a sub-set of the baseline characteristics as a function of the patient condition. The integrator is configured to aggregate the selected sub-set of the baseline characteristics to generate a patient-centric threshold for determining a patient status of the patient.

An exemplary embodiment to illustrate the techniques and tasks associated with generating the patient-centric threshold will be described in the context of monitoring a patient for hypertension. In that example, the integrator is programmed to select all variable parameters that impact hypertension, such as vital signs, diet, water quality, quality of life indices, prescription medicines, alternative medicines, occupation, family history, religious and tribal practices, and information the like.

The parameters are aggregated by the integrator 54 to generate a patient-centric threshold for the monitored patient. The generated patient-centric threshold is associated with an individual patient and tailored to that particular patient's condition. As such, each patient will have a separate and unique patient-centric threshold that is generated for each monitored condition of the patient.

Continuing with the example of a patient being monitored for hypertension, the parameters of each of the baseline characteristics are aggregated to generate an overall score. That overall score is then correlated to a sliding scale of risk values associated with hypertension to generate the patient-centric threshold. For example, the overall score is expressed as an integer value in the range of 1 to 10, with 1 indicating the worst or high-risk score and 10 indicating the best or low-risk score.

The overall score can then be correlated to actual acquired blood pressure readings as depicted in Table 3 below to generate the patient-centric threshold.

TABLE 3

| Patient- | | | | |
|---|---|---|---|---|
| Centric | Blood Pressure | Systolic | | Diastolic |
| Threshold | Category | Mm Hg | | Mm Hg |
| 1-2 | Normal | Less than 110 | and | Less than 60 |
| 3-4 | Prehypertension | 111-120 | or | 60-69 |
| 5-7 | Hypertension | 121-140 | or | 70-89 |
| | (Stage 1) | | | |
| 8-9 | Hypertension | 141 or higher | or | 90 or higher |
| | (Stage 2) | | | |
| 10 | Hypertensive | Higher than 160 | or | Higher than 95 |
| | Crisis | | | |

Returning to the aforementioned example, if the patient's blood pressure reading is 115/65 mm Hg and the patient's weight is 220 pounds, that patient is deemed to be a medium risk prehypertension patient.

Those skilled in the art will realize that such a conclusion is counterintuitive based on the conventionally established guidelines for blood pressure categories as defined by the American Heart Association. See “The AHA Guidelines and Scientific Statements Handbook,” edited by Valentin Fuster (2009). Nevertheless, the blood pressure categories defined in Table 3 are specific to the individual patient and are generated based on an amalgamation of that individual patient's baseline characteristics.

The processing device 52 will access the computed patient-centric threshold and perform a risk stratification of the patient's condition. As used in this disclosure, risk stratification refers to a systematic process for identifying and predicting a patient's risk level relating to health care needs, services, and coordination. One goal of risk stratification is to determine the severity of the patient's risk and prioritize the management of the patient's care to improve the patient's health outcomes. The risk stratification will enable maximization of the use of limited provider's time and resources to prioritize the needs of the patient population. Risk stratification will also enable the providers to forecast patient's health risks, prioritize interventions, and mitigate adverse outcomes.

In accordance with embodiments of this disclosure, the processing device 52 will perform a risk stratification of the acquired patient information based on the patient-centric threshold to determine a patient status of the patient. The risk stratification of the acquired patient information can comprise a comparative analysis of the acquired patient information to the patient-centric threshold values.

Based on the patient status identified as a function of the results of the comparative analysis, the processing device 52 will generate a recommendation of the treatment and/or care plan for the patient. In one illustrative example, a database (such as data source 10 or data store 14 in FIG. 1) is provided with a range of treatment/care plan options for the specific patient or for a patient population. Examples of the treatment/care plan options will include a medication prescription, literature pertaining to the monitored condition, a diet plan, a schedule for acquiring additional patient information corresponding to the monitored condition, and an exercise plan among other things.

To illustrate the range of recommended treatment/care plan options, the above example of a patient being monitored for hypertension will be revisited and the reader is referred to Table 3 in conjunction with this description. For instance, the first category “normal” would correspond to patients who have no health risks and for whom no medical intervention needs to be performed. The second category “prehypertension” can correspond to patients who require the least amount of resources with the primary goal for those patients being to prevent emergence of the disease. The recommended treatment/care plan for those patients can be lifestyle counseling, internet resources, patient engagement, motivational interviewing, lifestyle changes for weight loss, exercise and healthy diet. The third category “hypertension (stage 1)” can correspond to patients who will require moderate resource use. Patients in this category are treated for their condition and the goal is to avoid serious complications. The recommended treatment/care plan for those patients can be encouragement and support, home monitoring, family/care giver engagement, engage community resources, support groups, sub-specialty referrals as necessary, in person and online training, health coach, care plan. The fourth category “hypertension (stage 2)” can correspond to patients who will require high resource utilization. Patients in this category are in the late or final stages of the disease and the goal is to minimize disability or other related health complications. The recommended treatment/care plan for those patients can include intensive care management plan with assigned responsibility to a clinically trained team member, regular follow up and contact between visits, tracking ER visits, secondary sub-specialty referrals and hospitalizations. Finally, the fifth category “hypertensive crisis” can correspond to patients who will require extremely intensive resources. The disease condition of the patients in this category is catastrophic and the goal can range from restoring health to providing comfort care. The recommended treatment/care plan for those patients can include any of the aforementioned options and/or end of life planning, palliative care, hospice, intensive family/caregiver engagement and support.

The patient status will correspond to one of a list of predetermined patient statuses and each patient status will be correlated with one of more of the treatment/care plan options that are available for the patient. Consequently, the processing device 52 will generate the recommendation by selecting the appropriate treatment/care plan options from the range of treatment/care plan options. The generated recommendation is provided to the patient by at least one of generating an alert on the alert 61, transmitting the recommendation to a provider through the provider interface 18 and displaying the recommendation on the display device 64.

In one embodiment, the provider may review the recommendation prior to its transmission to the patient. The provider can review the recommendation through the provider interface 18 in conjunction with any other information such as the acquired patient information, the baseline characteristics, or the selected sub-set of baseline characteristics, and/or the patient-centric threshold. The provider can either confirm the recommendation in which case that recommendation is sent to the patient portal 4, or modify the recommendation in which such recommendation is modified and sent to the patient portal 4. The modified recommendation is also stored in the secondary storage system 42 for future use.

The prediction modeling module 35 will evaluate the modified recommendation to determine whether to permanently change the underlying computation that resulted in the initial recommendation or whether to simply add the modified treatment/care plan option as a new option. The prediction modeling module 35, alone or in conjunction with the processing device 52, will utilize a combination of preset criteria and user input to determine whether to make the permanent change or to add the modified treatment/care plan option as a new option. The criteria can include the level of deviation between the initial recommendation and the modified recommendation. If the prediction modeling module 35 determines that the modified recommendation is a new option, the initial treatment/care plan option is deleted and replaced by the modified treatment/care plan option and all future results of the comparative analysis by the processing device 52 will generate the modified treatment/care plan option. Alternatively, the modified treatment/care plan option is added as a new option that is selected by the processing device 52 in the event that the comparative analysis yields a patient status of the patient that is similar to the patient status that resulted in the initial recommendation.

In an embodiment, the processing device 52 can initiate an update of the patient's medical record that is stored on the patient portal 4, for example, in the input device 62 or in memory unit 34. The updated patient medical record can include the acquired patient information as well and/or the treatment/care plan. Depending on the specific aspects of the treatment/care plan, the processing device 52 may also monitor the patient compliance to the treatment/care plan as well as provide prompts, alerts or reminders to facilitate the compliance. For example, the processing device 52 may issue prompts, alerts or reminders for the patient to take the medication prescription, or to provide patient information for processing or to review medical education content, among other things.

For ease of discussion, the processing function has been described in the context of the processing device 52. However, it should be understood that the processing device 52 can either process the acquired patient information internally or communicate the information to another component of the system, such as processing server 16 for processing.

In an embodiment, the patient portal 4 is embodied as a single integrated device. In another embodiment, the patient portal 4 is embodied as two or more discrete units that are communicatively connected to perform the functions attributed to the patient portal 4. Moreover, in one or more of these embodiments, some of the functionality attributed to the patient portal 4 can alternatively or additionally be performed by other devices of the remote monitoring system 2 (FIG. 1). For example, the secondary storage system can be implemented within the database 14 or data source 10 and the patient portal 4 would simply communicate with the database or data source to retrieve information.

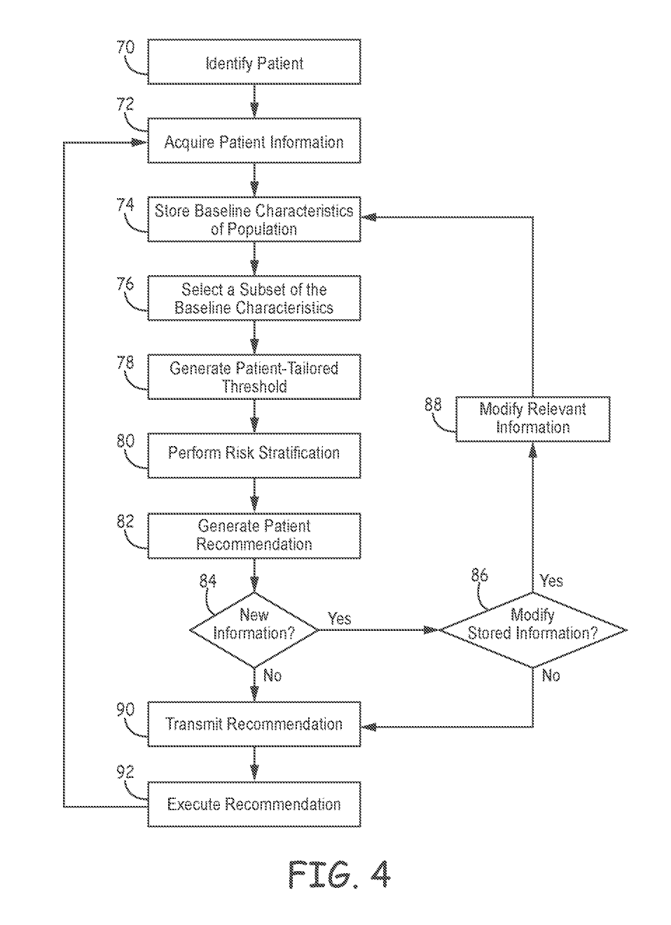

FIG. 4 is a flowchart illustrating a method or process for remote patient monitoring in accordance with embodiments of the present disclosure. The reader should refer to the foregoing figures in conjunction with the description of FIG. 4. The method can be implemented as computer readable instructions that are executed by one or more processors such as the processing device in the processing server 16 and/or processing device 52.

At task 70, an identity of the patient being monitored is verified or confirmed. Any of the aforementioned patient authentication techniques can be utilized to identify the patient.

Upon confirming the patient's identify, information corresponding to a condition of the patient is acquired at task 72. The patient information acquisition may utilize a sensor or any suitable input device such as the input device 52.

In some embodiments, the method of FIG. 4 contemplates storage of a set of baseline characteristics of a population that includes the patient at task 74. Such baseline characteristics can include information pertaining to the cultural and environmental parameters of the patient and various types of information that are relevant to the condition and/or treatment of a particular patient.

A sub-set of the baseline characteristics that is relevant to the patient's condition is selected and retrieved at task 76. The selected baseline characteristics will include information regarding the environment of the monitored patient and information regarding the condition of the patient. At task 78, the selected baseline characteristics are aggregated, analyzed or otherwise processed to generate a patient-centric or patient-tailored threshold that corresponds to the patient's condition being monitored.

The patient-centric threshold is utilized at task 80 to perform a risk stratification of the patient condition to determine a patient status of the patient. The patient status will correspond to the severity or criticality of the patient's condition on a predetermined scale. The risk stratification of the patient condition can comprise a comparative analysis of the acquired patient information to the patient-centric threshold values.

Based upon the results of the risk stratification, a recommended treatment/care plan is generated at task 82. The recommended treatment/care plan will be generated as a function of the determined patient status of the patient. Examples of the treatment/care plan options will include a medication prescription, literature pertaining to the monitored condition, a diet plan, a schedule for acquiring additional patient information corresponding to the monitored condition, or an exercise plan among other things.

The generated patient recommendation can be reviewed by a user such as a provider to determine the accuracy of the recommended treatment/care plan. Upon evaluating the generated recommendation, the user may confirm the suitability of the initial recommendation without further changes or cancel and provide a new and different recommendation or simply modify the initial recommendation to add or eliminate some aspects of the initial recommendation.

At task 84, the method evaluates input from the user to determine whether the initial recommendation has been confirmed as an appropriate recommendation or whether there is new information pertaining to the recommended treatment/care plan.

If new information has been provided, the method first determines whether to modify the existing databases at task 86. Modification in this context could include adding any received new recommendations to the existing recommendations options, or modifying the content of an existing recommendations option, or even modifying or adding to the existing baseline characteristics of the population. The evaluation on whether to modify existing content may be performed by prediction modeling module 35 as described above. If modification is appropriate, the relevant database is modified at task 88 by adding the information or modifying existing content.

Returning to task 84, if the user simply confirms that the initial recommendation is appropriate, the recommendation is transmitted to the patient, via patient portal 4 for example, at task 90. The recommendation is executed at task 92. Execution of the task includes performing the actions that are defined by the recommendation. For example, the recommendation can include generating an alert, defining an interval for acquisition of patient information, notifying the patient of a prescription through a display, or monitoring the patient's compliance to the treatment/care plan such as with a diet log, exercise log, etc. Thus, the foregoing describes a method of remotely monitoring a condition of a patient.

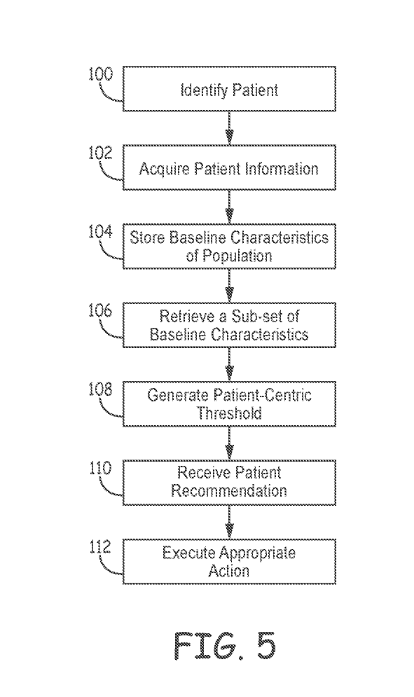

FIG. 5 is a flowchart illustrating a method or process performed by a patient portal during remote patient monitoring in accordance with embodiments of the present disclosure. The reader should refer to the foregoing FIGS. 1-3 in conjunction with the description of FIG. 5. The method can be implemented as computer readable instructions that are executed by one or more processors such as the processing device 52.

At task 100, an identity of the patient being monitored is verified or confirmed. In accordance with some embodiments, the patient portal may be uniquely associated with the patient being monitored and can contain personal information of the patient as well as information that is specifically tailored to the patient's condition. Any of the aforementioned patient authentication techniques can be utilized to identify the patient.

Upon confirming the patient's identify, information pertaining to a condition of the patient is acquired at task 102. The patient information acquisition may utilize a sensor or any suitable input device such as the input device 52. The patient or another user authorized by the patient can input information such as measurements of various physiological parameters or responses to patient self-assessment questions.

In some embodiments, the method of FIG. 5 contemplates storage of a set of baseline characteristics of a population that includes the patient at task 104. Such baseline characteristics can include information pertaining to the cultural and environmental parameters of the patient and various types of information that are relevant to the condition and/or treatment of a particular patient.

At task 106, a sub-set of the baseline characteristics that is relevant to the patient's condition is selected and retrieved. The selected baseline characteristics will include information regarding the environment of the monitored patient and information regarding the condition of the patient. At task 108, the selected baseline characteristics are aggregated, analyzed or otherwise processed to generate a patient-centric or patient-tailored threshold that corresponds to the patient's condition being monitored. The patient-centric threshold is associated with an individual patient and tailored to that particular patient's condition. As such, each patient will have a separate and unique patient-centric threshold that is generated for each given monitored condition of the patient.

A recommendation is subsequently received for the patient condition at task 110. The recommendation can be generated based on additional processing of the acquired patient information in conjunction with the patient-centric threshold, in conjunction with a provider's review of an initial system recommendation and/or solely based on the provider's review and analysis of the acquired patient information and the patient-centric threshold.

At task 112, the method concludes with execution of the appropriate action. In some embodiments, the received recommendation can be stored within the patient's patient portal and if appropriate existing data may be modified based on the recommended treatment/care plan. Modification in this context can include adding any received new recommendations to the existing recommendations options, or modifying the content of an existing recommendations option, or even modifying or adding to the existing baseline characteristics of the population. The evaluation on whether to modify existing content may be performed by prediction modeling module 35 as described above.

In embodiments, the execution of the received recommendation can be performed by the patient portal and/or any other appropriate devices in the remote monitoring computing system 2. For instance, the recommendation can include generating an alert, defining an interval for acquisition of patient information, notifying the patient of a prescription through a display, or monitoring the patient's compliance to the treatment/care plan such as with a diet log, exercise log, among other actions, all of which can be performed by the components of the remote monitoring computing system 2.

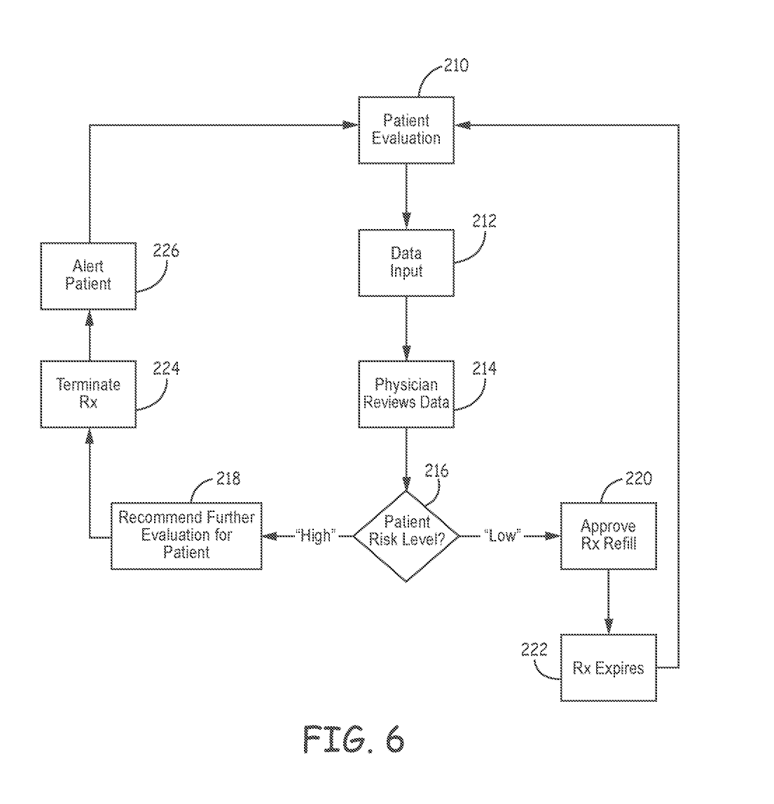

FIG. 6 is a flowchart presenting an overview of a method or process of remote patient monitoring in accordance with embodiments of the present disclosure. The reader should refer to the foregoing FIGS. 1-3 in conjunction with the description of FIG. 6. The method can be implemented as computer readable instructions that are executed by one or more processors such as the processing device in the processing server 16 and/or processing device 52.

At task 210, a patient having a condition such as a non-communicable disease is evaluated. For instance, a patient with hypertension would have their systolic and diastolic blood pressures measured. At task 212, patient information is obtained and input into a database. In one embodiment of the invention, after this data is uploaded successfully, a healthcare provider is alerted that new data is ready for review.

At task 214, a provider reviews the patient's data. Based on this review, the provider then evaluates, at task 216, whether the patient is a high- or low-risk based on the severity level of the patient's condition. If the patient is found to be at high-risk, the provider issues a notification to the patient that further evaluation is required at task 218. In some embodiments, an existing prescription for the patient can be terminated at task 224 and/or a notification can be issued to the patient via a patient portal to alert the patient of the recommendation to see the provider at task 226. Alternatively, if the patient is found to be at low- or no-risk, the provider can approve a recommended treatment/care plan, such as approving prescription medications for the patient at task 220. During this task, a corresponding pharmacy is also alerted as to the prescription approval.

At task 222, after the patient's prescription expires, the patient is required to seek evaluation 210 before being approved for further use of the prescription medication.

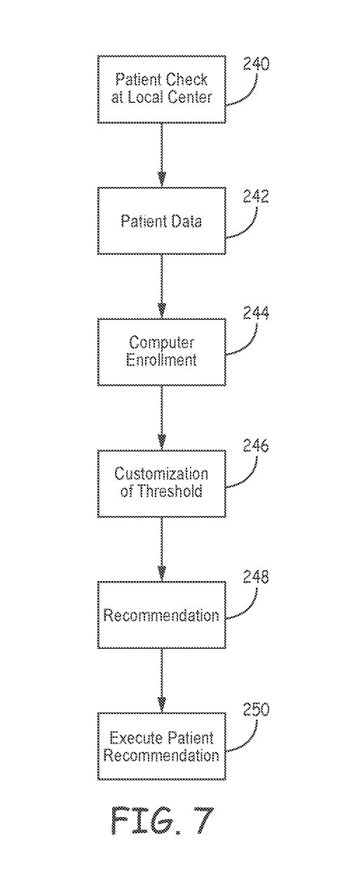

FIG. 7 is a flowchart presenting an overview of a method or process of remote patient monitoring in accordance with embodiments of the present disclosure. FIG. 7 pertains to methods or processes implemented by a provider interface, or in some cases the patient portal, within the remote monitoring system to enroll patients into a database as contemplated by the present invention. The reader should refer to the foregoing FIGS. 1-3 in conjunction with the description of FIG. 7. The method can be implemented as computer readable instructions that are executed by one or more processors such as the processing device in the processing server 16.

At task 240, a patient is examined by a provider at a local health center. A local health center can include a clinic, pharmacy, etc. At task 242, the patient information such as blood pressure, heart rate, etc., is acquired from the patient. At task 244, the patient is enrolled into the remote monitoring system and the provider can also issue an initial recommendation for the treatment/care plan of the patient's condition such as issuing the patient with a medication.

At task 246, a patient-centric threshold is computed for the patient based on the acquired patient information. This threshold is calculated by the present invention as a range of values. The range is based on a patient's physiological (i.e., diastolic and systolic blood pressure, resting heart rate, heart rate during physical activity, oxygen consumption), lifestyle (i.e., diet, frequency of exercise) measurements, cultural and environmental parameters. Additionally, the threshold calculated for a given patient can be recalculated after each acquisition of patient information as described in the above discussions. The patient-centric threshold is utilized in assessments of the acquired patient information to generate a recommended treatment/care plan for the patient at task 248. The appropriate actions necessitated by the patient recommendation are subsequently executed at task 250.

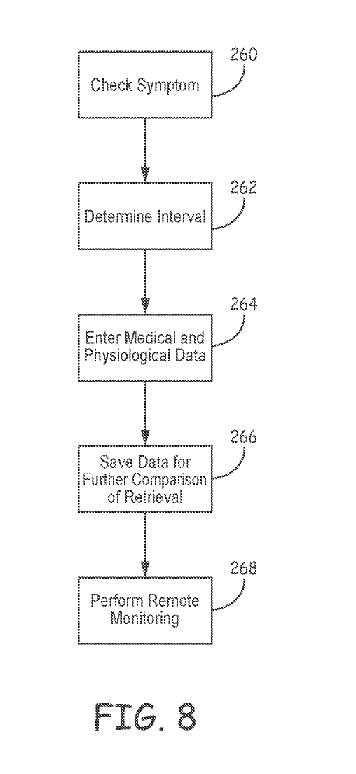

FIG. 8 is a flowchart presenting an overview of a method or process of remote patient monitoring in accordance with embodiments of the present disclosure. FIG. 8 pertains to methods or processes implemented by a provider interface within the remote monitoring system as contemplated by the present invention. The reader should refer to the foregoing FIGS. 1-3 in conjunction with the description of FIG. 8. The method can be implemented as computer readable instructions that are executed by one or more processors such as the processing device in the processing server 16.

At task 260, patient information pertaining to the patient's condition can be acquired or the provider can perform examination of a patient to obtain physiological information relating to the condition of the patient. The frequency of the data collection may be input at task 262. At task 264, the provider reviews the acquired patient information and confirms the data that is to be entered into the database along with any pertinent medical or physiological data relating to the patient's medical record.

The patient information is transmitted and stored at task 266 in the relevant database(s) or memory locations of various devices in the remote patient monitoring system. At task 268, the method proceeds with performance of the remote monitoring of the patient.

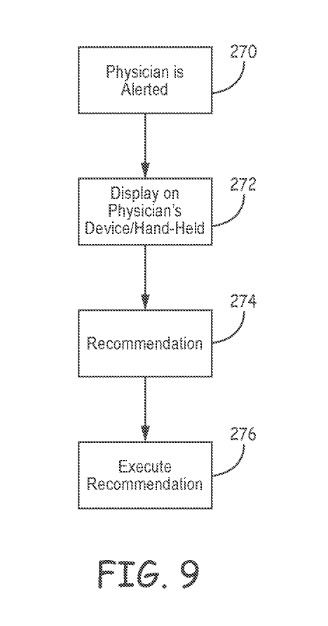

FIG. 9 is a flowchart presenting an overview of a method or process of remote patient monitoring in accordance with embodiments of the present disclosure. FIG. 9 pertains to methods or processes implemented by a provider interface within the remote monitoring system as contemplated by the present invention. The reader should refer to the foregoing FIGS. 1-3 in conjunction with the description of FIG. 9.

The method can be implemented as computer readable instructions that are executed by one or more processors such as the processing device in the processing server 16.

As described in the foregoing description, embodiments of the present invention contemplate performing a risk stratification of the patient's condition to determine the patient's level of risk. Patients classified as being of “low risk” on the aforementioned risk scale are considered to require little to no intervention since their condition is not deemed to be problematic. In contrast, “high risk” patients are considered to require some resources, the extent of which will be dependent on the severity of the condition. At task 272, an alert will be generated and transmitted to the provider interface along with any relevant information for patients who are of high risk. The information may include an initial recommendation that is generated by the processing device based on risk stratification techniques and a determined patient status of the patient.

Following at task 274, the physician can respond to the alert by reviewing the patient information, the generated recommendation and any other relevant information to confirm or modify the initial recommendation. The confirmed or modified recommendation is executed by the patient portal at task 276.

The foregoing subject matter of the present invention is described with specificity herein to meet statutory requirements. However, the description itself is not intended to limit the scope of the invention. Rather, the inventors have contemplated that the claimed subject matter might also be embodied in other ways, to include different tasks or combinations of tasks similar to the ones described in this document, in conjunction with other present or future technologies. Moreover, although the terms “task” and/or “block” may be used herein to connote different elements of methods employed, the terms should not be interpreted as implying any particular order among or between various tasks herein disclosed unless and except when the order of individual tasks is explicitly described. Moreover, in the drawings, the alphabetical suffixes on reference numbers for similar elements are not intended to indicate the presence of particular numbers of the elements. In this document, elements having names that start with ordinal words (e.g., “first,” “second,” “third,” and so) do not necessarily imply that the elements have a particular order. Rather, such ordinal words are merely used to refer to similar elements.

Providing software, firmware and hardware to accomplish the present invention, given the disclosure herein, is within the abilities of one of skill in the art. The connecting lines shown in the various figures contained herein are intended to represent example functional relationships and/or physical couplings between the various elements. It should be noted that many alternative or additional functional relationships or physical connections may be present in an embodiment of the subject matter.

While the disclosure is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

What is claimed is:

1. A computing system for remotely monitoring a patient, the system comprising:
a patient-portal network that comprises a multiplicity of communicatively coupled patient-portal devices,
wherein each patient-portal device is configured to have a plurality of input sources operable to acquire patient information corresponding to a condition of the monitored patient, and
wherein each patient-portal device is configured to determine an identity of the patient based on an authentication scheme performed by the patient-portal;
a data source communicatively coupled to the patient-portal network, the data source being configured to store data received by the patient-portal network;
a patient database configured to store baseline characteristics of a population,
wherein the baseline characteristics include information regarding the culture, environment, societal norms, religion, or economic conditions of the monitored patient and information regarding the condition of the patient;
a provider interface network that comprises a multiplicity of communicatively coupled provider interface devices,
wherein each provider interface device is configured to receive an alert based on a recommendation generated by a processing device;
a communications network that facilitates communication between the data source, provider interface network, and the patient database, the communications network being configured to:
select a sub-set of the baseline characteristics as a function of the patient condition; and
aggregate the selected sub-set of the baseline characteristics to generate a patient-centric threshold associated with the condition of the monitored patient,
wherein the patient-centric threshold corresponds to a predetermined acceptable risk limit of the condition,
and comprises a processing device coupled to the communications network, the processing device configured to:
access the patient-centric threshold from the integrator;
perform a risk stratification of the acquired patient information based on the patient-centric threshold to determine a condition status of the patient; and
generate an alert based on the recommendation; and
a transceiver communicatively coupled to the processing device, the transceiver being configured to transmit the recommendation to a provider interface and receive input from the provider interface.

2. The computing system of claim 1, wherein the processing system is further configured to store the recommendation in the patient database.

3. The computing system of any one of claims 1-2, further comprising a prediction modeling module coupled to the processing device, the prediction modeling module including information for performing the risk stratification.

4. The computing system of any one of claims 1-3, wherein the plurality of input sources includes one of a device activated by an input from the patient to acquire the patient information, a device operable to automatically measure a parameter associated with the condition to acquire the patient information, and a device operable to continuously measure the parameter associated with the condition to acquire the patient information.

5. The computing system of any one of claims 1-4, wherein the recommendation is derived from a plurality of recommendation options stored within the patient database.

6. The computing system of any one of claims 1-5, wherein the selected sub-set of the baseline characteristics include at least one of a cultural parameter associated with the population, an environmental parameter associated with the population, a patient condition parameter associated with the patient, and a medication parameter associated with the patient.

7. The computing system of any one of claims 1-6, wherein the processing device is further configured to modify the information in the patient database based on the recommendation.

8. The computing system of claim 7, wherein the modification performed by the processing device comprises updating a medical record associated with the patient.

9. The computing system of any one of claims 1-8, wherein the provider interface includes an input interface for receiving an input from a provider, the input comprising at least one of modifying the recommendation, issuing a medication prescription, and issuing a medical literature.

10. The computing system of claim 9, wherein the processing device is further configured to transmit at least one of the modified recommendation, the medication prescription and the medical literature to the patient portal.

11. The computing system of claim 9, wherein the processing device is further configured to modify a medical record of the patient based on the provider input.

12. The computing system of claim 1-11, wherein the patient portal includes one of a custom computing device, a software application implemented on a mobile phone, tablet or wearable device, and a web interface.
